(19) United States
(12) Patent Application Publication
(10) Pub. No.: US 2024/0158936 A1
(43) Pub. Date: May 16, 2024

(54) METHOD FOR PREPARING CARBON NANODOT-MODIFIED NICKEL PHOSPHIDE NANOSHEET AND USE THEREOF IN WATER ELECTROLYSIS

(71) Applicant: UEST of China, Yangtze River Delta RI (Huzhou), Huzhou City (CN)

(72) Inventors: Zhaojun Qin, Huzhou City (CN); Weiwu Chen, Huzhou City (CN); Zhiming Wang, Huzhou City (CN); Runbo Zhao, Huzhou City (CN); Yisen Yao, Huzhou City (CN)

(73) Assignee: UEST of China, Yangtze River Delta RI (Huzhou), Huzhou City (CN)

(21) Appl. No.: 18/495,433

(22) Filed: Oct. 26, 2023

(30) Foreign Application Priority Data
Nov. 10, 2022 (CN) CN 202211407673X

(51) Int. Cl. C25B 11/091; C25B 1/04; C25B 15/031

(52) U.S. Cl. CPC C25B 11/091; C25B 1/04; C25B 15/031

(57) ABSTRACT

The present disclosure discloses a method for preparing a carbon nanodot-modified nickel phosphide nanosheet and a use thereof as auxiliary materials in water electrolysis. The preparation steps include: preparing water solution containing carbon nanodots; attaching the carbon nanodots to the surface of a hydrogen-producing electrode in water electrolysis; and annealing the hydrogen-producing electrode with carbon nanodots. The carbon nanodots obtained by this preparation method have extremely small sizes and relatively uniform diameters, facilitating the attachment with other materials, and the integration of these carbon nanodots with the hydrogen-producing electrode in water electrolysis significantly enhances the hydrogen production efficiency, substantially reducing the cost required for hydrogen production through water electrolysis.

### CROSS-REFERENCE TO RELATED APPLICATIONS

This, application claims priority to Chinese Patent Application No. 202211407673.X, filed on Nov. 10, 2022. The disclosure of the application is incorporated herein for all purposes by reference in its entirety.

### TECHNICAL FIELD

The present disclosure relates to the field of water electrolysis for hydrogen production, and more particularly, to a method for preparing a carbon nanodot-modified nickel phosphide nanosheet and a use thereof in water electrolysis.

### BACKGROUND

Nickel phosphide possesses high stability and strong catalytic activity, and has maintained a significant role in the field of cathodes for water electrolysis for hydrogen production. Like other catalytic materials, the factors that influence the catalytic performance of materials for water electrolysis hydrogen production mainly include the intrinsic catalytic activity of the material, charge transfer properties, specific surface area, and the number of active sites they offer. Therefore, to enhance the catalytic performance of materials for water electrolysis hydrogen production, methods such as heteroatom doping, surface modification, and layered structure design are commonly employed to enhance the aforementioned material characteristics.

However, for surface modification and layered structure design, operational difficulties often arise due to size limitations. Thus, the introduction of a substance that is not restricted by size to modify the surface of the catalytic material offers significant application value in enhancing its catalytic performance. Nanodots are a type of zero-dimensional nanomaterial, possessing extremely small dimensions, allowing them to adhere to other macroscopic, microscopic, or, even higher-dimensional nanomaterials. Carbon nanodots exhibit the microscopic properties of nanomaterials sand also possess good stability, capable of remaining stable in solutions of various pH levels, and are thus applied to many scenarios. Therefore, developing a method for preparing carbon nanodot-modified nickel phosphide nanosheets and applying them as cathode for water electrolysis is both feasible and valuable.

### SUMMARY

In view of the aforementioned prior art, the present disclosure provides a method for preparing a carbon nanodot-modified nickel phosphide nanosheet, which may be applied as a water electrolysis cathode.

To achieve the aforementioned objectives, the technical solution adopted by the present disclosure is: a method for preparing a carbon nanodot-modified nickel phosphide nanosheet, including the following steps:
S1: is providing two graphite rods as positive and negative electrodes and deionized water as electrolyte, and applying a voltage of 20-25 V between the two graphite electrodes, by a constant voltage power supply, for 100-120 hours to obtain carbon nanodot solution;
S2: immersing an array of Ni₅P₄ nanosheets into the carbon nanodot solution for a few seconds, then removing them for naturally drying;
S3: placing the Ni₅P₄ nanosheets with carbon nanodots in a tube furnace, for example, at a central position, adjusting internal atmosphere of the tube furnace with argon gas (or introducing argon gas), and heating the tube furnace to 480° C.-500° C. and maintaining it for 50-60 minutes, then cooling to obtain stable carbon nanodot-modified. Ni₅P₄ nanosheets.

In some embodiments, applying a voltage of 25 V between the two graphite electrodes, by the constant voltage power supply, for 120 hours.

In some embodiments, heating the tube furnace to 500° C. and maintaining it for 60 minutes.

In some embodiments, carbon nanodot solution is obtained by the method for preparing the carbon nanodot-modified nickel phosphide nanosheet. The obtained carbon nanodot has a uniform size, with a diameter of approximately 5 nm, making it suitable for integration with other cathodes for water electrolysis.

This disclosure also provides a use of the carbon nanodot-modified nickel phosphide nanosheet, in which the carbon nanodot-modified nickel phosphide nanosheet, is directly employed as a water electrolysis cathode of a water electrolysis device, the water electrolysis device comprises the carbon nanodot-modified Ni₅P₄ nanosheet, a graphite paper counter-electrode, an Hg/HgO reference electrode, and potassium hydroxide electrolyte, wherein the potassium hydroxide electrolyte has a pH value of 14

The advantageous effects of the present disclosure are as follows: the preparation method is simple and safe, capable of producing a large amount of carbon nanodots with uniform size. Upon attachment of the carbon nanodots to Ni₅P₄ nanosheets, the electrochemically active surface area of Ni₅P₄ nanosheets is significantly increased, and the carbon nanodots serving as active sites increase the rate of charge transfer during water electrolysis. Therefore, the electrocatalytic performance of NO₅P₄ nanosheets for water electrolysis is significantly improved after being combined with, carbon nanodots.

### BRIEF DESCRIPTION OF THE DRAWINGS

FIG. 1 is a transmission electron microscope image of the carbon nanodots in the present disclosure; and

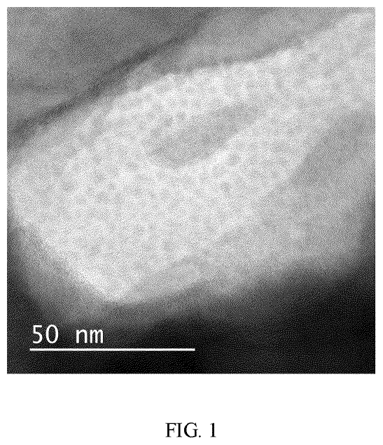

FIG. 2 is a polarization curve of a Ni₅P₄ nanosheet cathode for water electrolysis, modified with carbon nanodots in the present disclosure.

### DETAILED DESCRIPTION

The technical solutions in the embodiments of the present disclosure will be clearly and completely described below in conjunction with the accompanying drawings in the embodiments of the present disclosure. Apparently, the described embodiments are only part of the embodiments of the present disclosure, not all of them. Based on the embodiments of the present disclosure, all other embodiments obtained by those skilled in the art without inventive effort shall fall within the scope of protection of the present disclosure.

The present disclosure relates to a method for preparing a carbon nanodot-modified nickel phosphide nanosheet and a use thereof in terms of the cathode for water electrolysis, which includes the following steps:
Step S1: Utilizing, two graphite rods as an anode and cathode, with deionized water serving as electrolyte, applying a voltage of 20-25 V between the two graphite electrodes using a constant voltage power supply, and continuing this for 100-120 hours to ultimately obtain a carbon nanodot solution.
Step S2: Immersing an array of Ni₅P₄ nanosheets into the carbon nanodot solution for a few seconds, then removing them, for naturally drying.
Step S3: Placing the carbon nanodot-attached Ni₅P₄ nanosheets at a central position within a tube furnace. Adjusting the internal atmosphere of the tube furnace with argon gas. Heating the central position of the tube furnace to 480-500° C. and maintaining it for 50-60 minutes. After cooling, stable carbon nanodot-modified Ni₅P₄ nanosheets are obtained.

In some embodiments, applying a voltage of 25 V between the two graphite electrodes using the constant voltage power supply, and continuing for 120 hours to obtain the carbon nanodot solution.

In some embodiments, heating the central position of the tube furnace to 500° C. and maintaining for 60 minutes to obtain the stable carbon nanodot-modified Ni₅P₄ nanosheet.

In some embodiments, the carbon nanodot-modified nickel phosphide nanosheet can be directly employed as the cathode for water electrolysis in a water electrolysis device/system, the water electrolysis device comprises the carbon nanodot-modified Ni₅P₄ nanosheet cathode for water electrolysis, a graphite paper counter-electrode, an Hg/HgO reference electrode, and a potassium hydroxide electrolyte, wherein the graphite paper can be replaced by other materials with similar electrochemical performance for the water electrolysis anode, and the pH value of the potassium hydroxide electrolyte is 14.

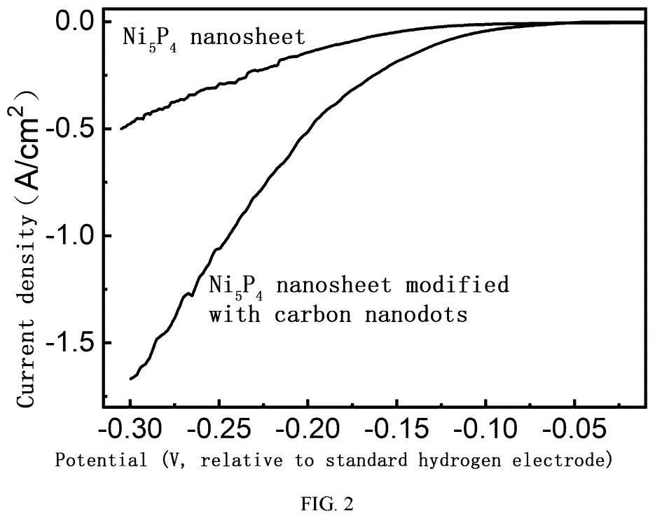

In some embodiments, carbon nanodot solution is obtained by the method for preparing the carbon nanodot-modified nickel phosphide nanosheet. The obtained carbon nanodot has a uniform size, with a diameter of approximately 5 nm, making it suitable for integration with other cathodes for water electrolysis. As shown in FIG. 2, the curvature of the corresponding curve for the Ni₅P₄ nanosheets modified with carbon nanodots is much higher than that of the corresponding curve for the Ni₅P₄ nanosheets, indicating that under the same applied voltage conditions, the Ni₅P₄ nanosheets modified with carbon nanodots result in higher current density, thus producing more hydrogen gas. That is, the obtained Ni₅P₄ nanosheets modified with carbon nanodots only require a relative potential of 63 mV to reach a current density of 10 mA/cm², which is significantly lower than the 94 mV required by the conventional Ni₅P₄ nanosheets to reach a current density of 10 mA/cm².

Although the present disclosure has been described in detail with reference to the foregoing embodiments, it should not be understood, as limiting the scope of the disclosure. Any modification and variation that can be made by those skilled in the art within the scope of the claims without inventive effort are still within the scope of protection.

1. A method for preparing a carbon nanodot-modified nickel phosphide nanosheet, comprising the following steps:
S1: providing two graphite rods as positive and negative electrodes and deionized water as electrolyte, and applying a voltage of 20-25 V between the two graphite electrodes, by a constant voltage power supply, for 100-120 hours to obtain carbon nanodot solution;
S2: immersing an array of Ni₅P₄ nanosheets into the carbon nanodot solution for a few seconds, then removing them for naturally drying;
S3: placing the Ni₅P₄ nanosheets with carbon nanodots in a tube furnace, adjusting internal atmosphere of the tube furnace with argon gas, and heating the tube furnace to 480° C.-500° C. and maintaining it for 50-60 minutes, then cooling to obtain carbon nanodot-modified Ni₅P₄ nanosheets.

2. The method for preparing the carbon, nanodot-modified nickel phosphide nanosheet of claim 1, wherein, applying a voltage of 25 V between the two graphite electrodes, by the constant voltage power supply, for 120 hours.

3. The method for preparing the carbon nanodot-modified nickel phosphide nanosheet of claim 1, wherein, heating the tube furnace to 500° C. and maintaining it for 60 minutes.

4. A use of the carbon nanodot-modified nickel phosphide nanosheet of claim 1, wherein, the carbon nanodot-modified nickel phosphide nanosheet is directly employed as a water electrolysis cathode of a water electrolysis device, the water electrolysis device comprises the carbon nanodot-modified Ni₅P₄ nanosheet, a graphite paper counter-electrode, an Hg/HgO reference electrode, and potassium hydroxide electrolyte, wherein the potassium hydroxide electrolyte has a pH value of 14.
